(19) United States
(12) Patent Application Publication
(10) Pub. No.: US 2006/0163179 A1
(43) Pub. Date: Jul. 27, 2006

(54) Document management system and associated method

(76) Inventor: Robert J. Schendel, Novi, MI (US)

Correspondence Address: HARNESS, DICKEY & PIERCE, P.L.C., P.O. BOX 828, BLOOMFIELD HILLS, MI, 48303, US

(21) Appl. No.: 11/332,870

(22) Filed: Jan. 13, 2006

Related U.S. Application Data
(60) Provisional application No. 60/644,114, filed on Jan. 14, 2005.

(51) Int. Cl. A47F 7/14; G06K 9/18

(52) U.S. Cl. 211/55; 382/184

(57) ABSTRACT

A document management system that includes a modular storage device. The modular storage device includes at least one storage unit for supporting a plurality of vertically staggered storage folders. Each storage folder defines a pocket having a pocket depth for storing document management objects. The storage folders are supported such that the object in each storage folder is visible and such that the pocket of each storage folder can be reduced or increased relatively to a standard pocket depth.

### INTRODUCTION

Various file storage systems are currently available, including horizontal and vertical file storage systems. Although such systems are adequate for their intended purposes, there is still a need for a cost-efficient, flexible, simple, and adjustable document management system and associated document management method.

### SUMMARY

The present teachings provide a document management system that includes a modular storage device. The modular storage device includes at least one storage unit for supporting a plurality of vertically staggered storage folders. Each storage folder defines a pocket having a pocket depth for storing document management objects. The storage folders are supported such that the object in each storage folder is visible and such that the pocket of each storage folder can be reduced or increased relatively to a standard pocket depth.

The present teachings also provide a document management system that includes at least two vertical supports. Each support includes two columns of spaced-apart apertures for hanging storage folders therebetween. Each storage folder has a pocket depth and is movable between first and second configurations having different pocket depths.

The present teachings also provide a method for storing document management objects. The method includes providing at least two vertical supports, wherein each vertical support has at least two columns of spaced apart apertures, and hanging a first storage folder between the vertical supports such that a front edge of the first storage folder is at a different horizontal level than a back edge of the first storage folder.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of an exemplary document management system according to the present teachings, shown with an exemplary folder arrangement;

FIG. 1A is an enlarged view of Detail 1A of FIG. 1, showing a nested folder arrangement;

FIG. 2 is a front view of the document management system of FIG. 1;

FIG. 3 is a front view of an exemplary document management system according to the present teachings, illustrated with an exemplary folder arrangement in two single-column storage units;

FIG. 4 is a perspective view of an exemplary document management system according to the present teachings, illustrated as one multi-column storage unit mounted on a wall;

FIG. 5 a perspective view of an exemplary document management system according to the present teachings, shown with an exemplary folder arrangement;

FIG. 6 is the document management system of FIG. 5, illustrating a mounting arrangement for making the storage pocket of the folder larger; and

FIG. 7 is the document management system of FIG. 5, illustrating a mounting arrangement for making the storage pocket of the folder smaller.

### DETAILED DESCRIPTION

The following description is merely exemplary in nature and is in no way intended to limit the invention, its application, or uses.

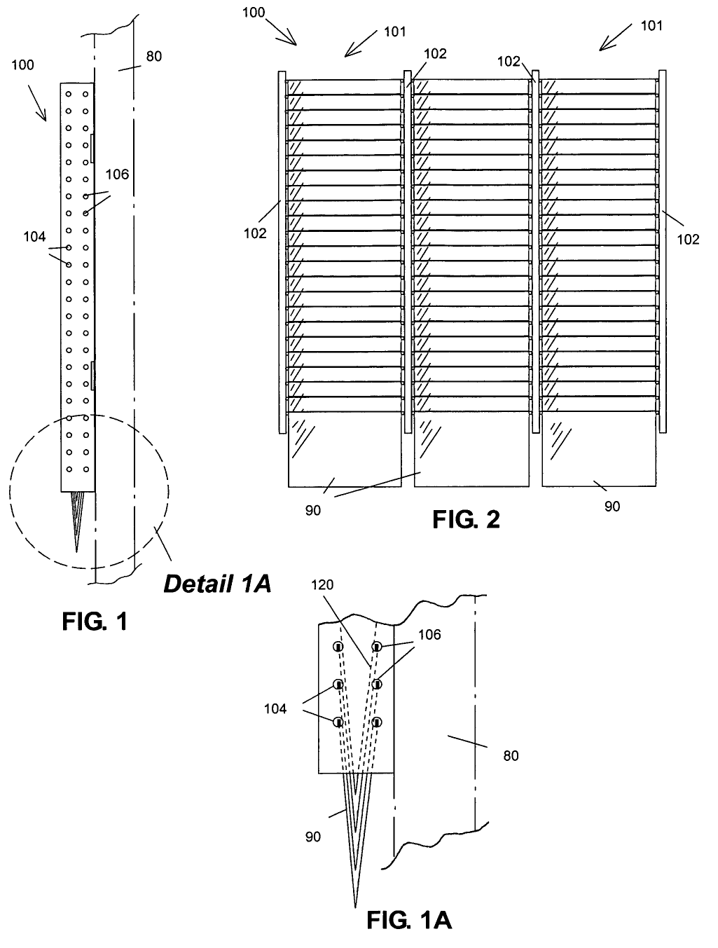

Referring to FIGS. 1, 2 and 3, various views of an exemplary document management system 100 in the form of a modular storage device according to the present teachings are shown as mounted on a wall 80. In one aspect, the document management system 100 is adapted for the storage of cards, information sheets, files, folders and the like, or any flat objects, all of which are included in the generalized term “document management objects”, as used herein.

Referring to FIGS. 1-5, the document management system 100 can be configured for displaying hanging folders 90 in vertical rows (columns) and in a vertically staggered manner, such that the contents of the folders are visually accessible at a glance. Referring to FIG. 1A, the hanging folders 90 can be arranged in a nested configuration, wherein each folder 90 can be partially received in a pocket 120 another folder 90.

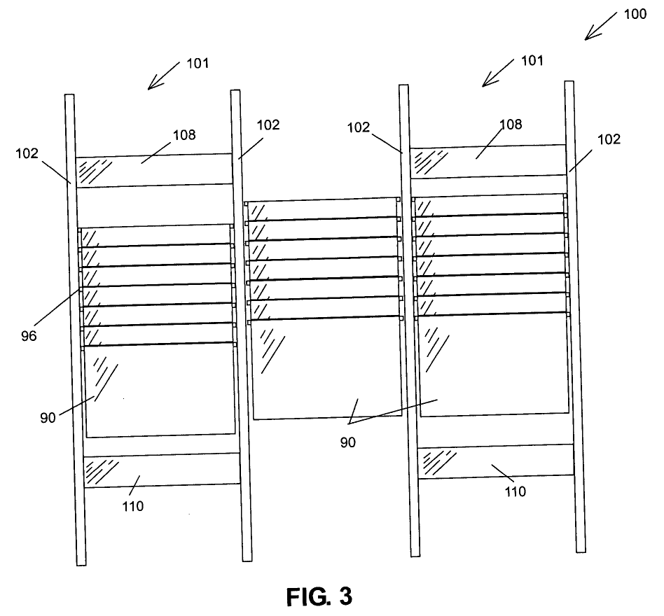

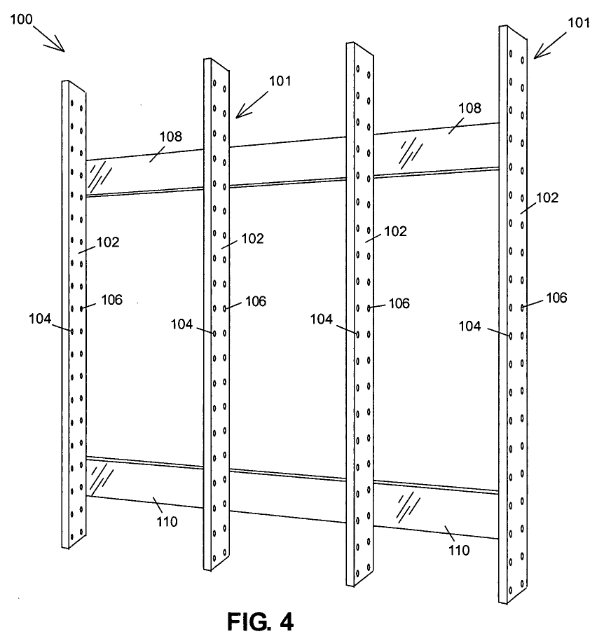

Referring to FIGS. 3 and 4, the document management system 100 can include one or more storage units 101, with each storage unit 101 configured as a single-column or multiple-column storage units 101 for accommodating one or more columns of folders 90. In FIG. 3, each storage unit 101 accommodates one folder column. In FIG. 4, the storage unit 101 accommodates three folder columns. Two storage units 101 can be spaced apart at a distance that can accommodate another column of folders 90, such that, for example, two single-column storage units 101 can be used to store three folder columns, as illustrated in FIG. 3. It will be appreciated that the document management system 100 can comprise any number of single-column or multiple-column storage units 101 that can be modularly combined to suit the available space and or number of folders 90.

With continued reference to FIGS. 3 and 4, each storage unit 101 can include two vertical supports 102. Each support 102 can have first and second pluralities of equally spaced holes or apertures 104, 106. Each storage unit 101 can also include an upper stabilizing member 108 and a lower stabilizing member 110. The upper and lower stabilizing members 108, 110 can be coupled with the vertical supports 102 with snap-on connections, fasteners, or other known coupling means. In particular, the vertical supports 102 can be removably coupled with the horizontal members 108, 110 at pre-determined and/or arbitrary locations. Additional horizontal stabilizing members 108, 110 can be added, as necessary. The holes 104, 106 are configured on each vertical support 102 in two spaced-apart columns of holes, one column behind the other (front column and back column). The hole columns can be provided on a single face, or on both faces of each vertical supports 102. The holes 104, 106 can also be through holes. At each horizontal level, a pair of front holes 104 can be used to hang a front edge 122 of one folder 90, and a pair of back holes 106 can be used to hang a back edge 124 of the folder 90. Although two vertical columns of holes 104, 106 are illustrated on each vertical support 102, it will be appreciated that additional hole columns can be provided on each vertical support 102 to accommodate folders 90 of different pocket space widths.

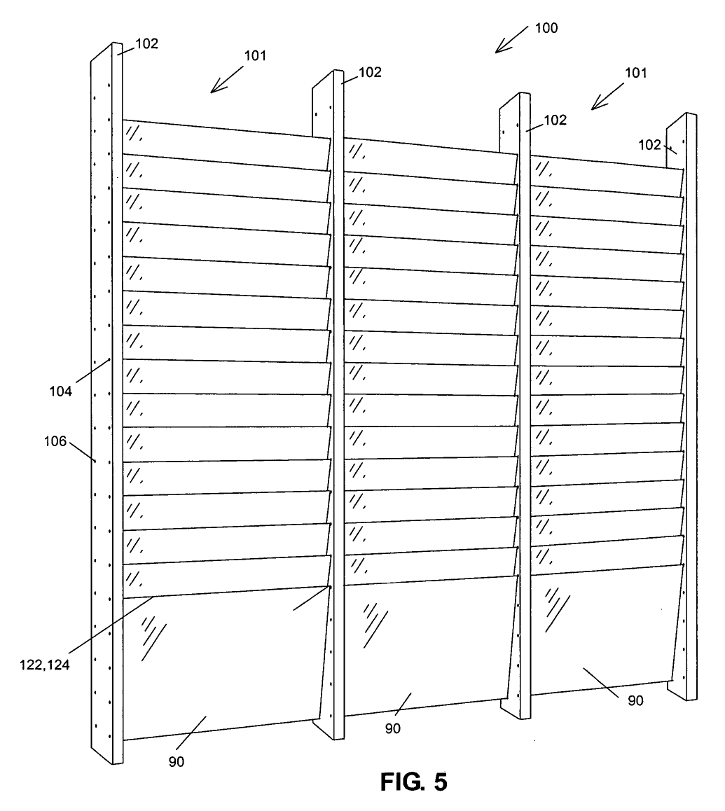

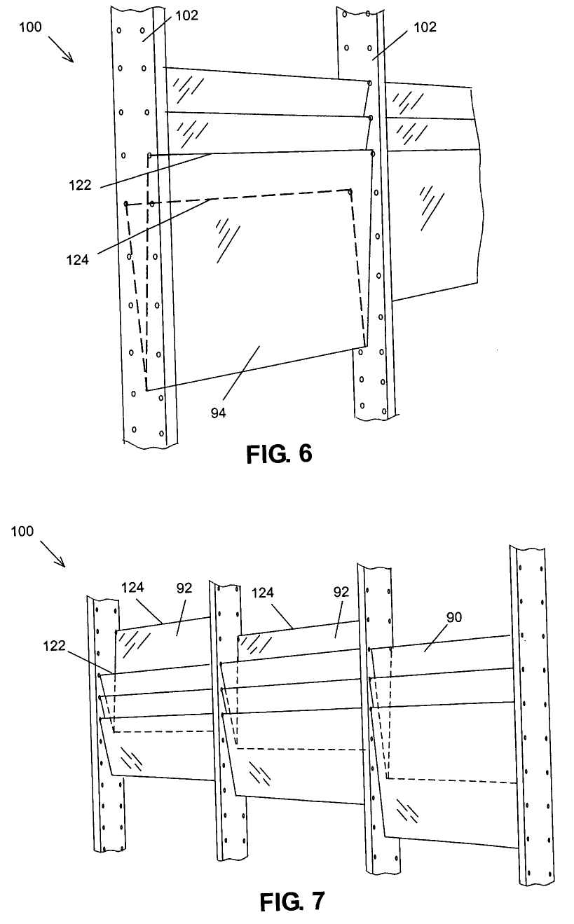

Referring to FIGS. 5-7, the folders 90 can be hung on the supports 102, such that their front and back edges 122, 124 are on the same horizontal level, in the standard folder configuration illustrated at reference 90, in FIG. 5. Alternatively, some folders 94, 92 can be folded such that their back edges 124 are hung lower or higher than their front edges 122 to provide, respectively, larger or smaller length pockets 120 for longer documents or shorter documents, as illustrated in FIGS. 6 and 7. Any folder 90 in any folder column can be reconfigured to have a different size pocket by refolding the folder 90 and re-hanging the back edge 124 of the folder 90 to a pair of back holes 106 that are at the same or different horizontal level relative to the holes 104 that receive the front edge of the folder 90. It will be further appreciated that the vertical supports 102 can be spaced apart at different distances to accommodate letter size, legal size or other paper size folders 90.

The vertical supports 102 and the horizontal stabilizing members 108, 110 can be made from any convenient and cost-effective material, including any type of wood, plastic, composite or metal. The folders 90 can be any hanging-style folders 90, such as, for example, Pentaflex® or similar style folders which include hanging bars 96 for engaging the holes 104, 106.

The foregoing discussion discloses and describes merely exemplary arrangements of the present invention. One skilled in the art will readily recognize from such discussion, and from the accompanying drawings, that various changes, modifications and variations can be made therein without departing from the spirit and scope of the invention.

What is claimed is:

1. A document management system comprising:
a modular storage device comprising at least one storage unit for supporting a plurality of vertically staggered storage folders, each storage folder defining a pocket having a pocket depth for storing document management objects, the storage folders supported such that the object in each storage folder is visible and such that the pocket of each storage folder can be reduced or increased relatively to a standard pocket depth.

2. The document management system of claim 1, wherein each storage unit is defined between two vertical supports, each support having at least two columns of spaced apart apertures for supporting the storage folders and allowing change in pocket depth.

3. The document management system of claim 1, wherein at least two of the storage folders are arranged in a nested configuration.

4. The document management system of claim 1, comprising three columns of spaced apart apertures for allowing change in pocket width.

5. The document management system of claim 1, wherein each folder includes front and back edges and each folder can be supported such that the front and back edges are at the same horizontal level or at different horizontal levels.

6. The document management system of claim 2, further comprising at least one stabilizing member coupled to the vertical supports.

7. A document management system comprising:
at least two vertical supports, each support comprising two columns of spaced apart apertures for hanging storage folders therebetween, each storage folder having a pocked depth and movable between first and second configurations having different pocket depths.

8. The document management system of claim 7, wherein at least two of the storage folders are arranged in a nested configuration.

9. The document management system of claim 7, comprising at least three vertical supports defining two storage units.

10. The document management system of claim 9, wherein the storage folders of each storage unit are vertically staggered.

11. The document management system of claim 7, comprising three columns of spaced apart apertures for allowing change in pocket width.

12. The document management system of claim 7, wherein each folder includes front and back edges and each folder can be supported such that the front and back edges are at the same horizontal level or at different horizontal levels.

13. A method for storing document management objects comprising:
providing at least two vertical supports, each vertical support having at least two columns of spaced apart apertures; and
hanging a first storage folder between the vertical supports such that a front edge of the first storage folder is at a different horizontal level than a back edge of the first storage folder.

14. The method of claim 13, further comprising hanging a second storage folder in nested relationship with the first storage folder.

15. The method of claim 13, further comprising hanging a second storage folder between the vertical supports, such that front edge and back edges of the second storage folder are at a same horizontal level.

16. The method of claim 13, further comprising changing a pocket depth of the first storage folder.

17. The method of claim 13, further comprising changing a pocket width of the first storage folder.
